(19) United States
(12) Patent Application Publication
(10) Pub. No.: US 2026/0064892 A1
(43) Pub. Date: Mar. 5, 2026

(54) AGREEMENT-BASED GOVERNANCE PROCESSOR SYSTEM FOR SECURE AI LIFECYCLEMANAGEMENT AND DISTRIBUTED COMPUTING

(71) Applicant: Nusantao IP, LLC, Casper, WY (US)

(72) Inventor: Raymond Vincent Corning, JR., Lander, WY (US)

(21) Appl. No.: 19/317,035

(22) Filed: Sep. 2, 2025

Related U.S. Application Data
(60) Provisional application No. 63/689,469, filed on Aug. 30, 2024.

(51) Int. Cl. G06F 21/72; G06F 9/50; G06F 21/60

(52) U.S. Cl. CPC G06F 21/72; G06F 9/5011; G06F 9/5077; G06F 21/602; G06F 2221/2143

(57) ABSTRACT

The present disclosure provides a governance processor system for secure AI lifecycle management across distributed computing environments. The governance processor is a new category of hardware distinct from application processors (CPUs, GPUs, TPUs) and security processors (TPMs, secure elements), designed to enforce policies and agreements at the hardware level. A policy specification layer defines access controls, data flow rules, execution limits, and cleanup requirements, which are compiled into hardware-executable routing and verification instructions. Governance processors, distributed across clusters, enforce these instructions at hardware control points governing data ingress, processing launch, and result egress. Each processor includes a three-domain architecture comprising an immutable enforcement core, an isolated local scripting language-based management plane, and a cryptographic engine. This design enables secure training, protected model deployment, confidential inference, zero-knowledge state maintenance, and manufacturer-independent updates. By dynamically configuring software-defined enclaves with hardware-enforced boundaries, the system ensures end-to-end AI governance with enhanced security, flexibility, and vendor independence.

### CROSS-REFERENCE TO RELATED APPLICATIONS

This application claims the benefit of U.S. Provisional Patent Application No. 63/689,469, filed Aug. 30, 2024, entitled “Integrated Secure Computing System and Method for Content Creation and AI Lifecycle Management,” which is hereby incorporated by reference in its entirety.

### FIELD

The present disclosure relates generally to the field of artificial intelligence (AI) security and lifecycle management within distributed computing environments. More particularly, the present disclosure concerns a hardware-based governance processor system that enforces policies, agreements, and security controls at the processor level, distinct from traditional application and security processors. The present disclosure further relates to the use of governance processors for managing AI model training, inference, storage, and deployment across clusters and enclaves, with hardware-enforced isolation, cryptographic protection, and lifecycle governance.

### BACKGROUND

Artificial intelligence (AI) systems are increasingly deployed across distributed computing environments, including cloud platforms, high-performance computing clusters, and edge devices. These systems rely on large-scale computational resources such as CPUs, GPUs, and TPUs for model training and inference. While existing hardware provides significant computational power, current architectures lack mechanisms for hardware-level policy enforcement and lifecycle governance.

Conventional approaches to AI security depend primarily on software-based controls, such as hypervisors, containerization, or trusted execution environments (TEEs), which remain vulnerable to compromise through operating system exploits, driver vulnerabilities, and supply chain attacks. Security processors, such as TPMs and secure elements, provide cryptographic primitives but do not enforce operational policies across heterogeneous compute clusters. Application processors, by contrast, execute workloads but are not designed to mediate data access, execution boundaries, or cleanup procedures.

As a result, organizations face critical challenges in:
Securing training data and models across distributed infrastructures;
Isolating AI workloads in multi-tenant or adversarial environments;
Maintaining zero-knowledge state between operations;
Applying stakeholder agreements directly to hardware-level execution policies; and
Breaking dependency on manufacturers for firmware and microcode updates.

Without a hardware-based governance mechanism, AI operations remain susceptible to data leakage, unauthorized access, policy circumvention, and vendor lock-in. There is therefore a need for a new category of processor, a governance processor, that enforces security policies and agreements directly at the hardware level, providing end-to-end lifecycle management for AI systems operating in distributed and potentially untrusted environments.

### SUMMARY

The present disclosure provides a governance processor system for secure lifecycle management of artificial intelligence (AI) operations across distributed computing environments. Unlike traditional application processors, which perform computation, or security processors, which provide cryptographic primitives, the governance processor introduces a new category of hardware dedicated to policy enforcement and governance at the processor level.

Stakeholder agreements are created in human readable format (one example being json which are converted into self-executing agreements or smart contracts, which are self-executing agreements with the terms of the contract directly written into code. These contracts automatically enforce and execute actions when predefined conditions are met, without requiring intermediaries. Within the governance processor system, smart contracts can be used to formalize stakeholder policies, automate compliance, and ensure that control logic, such as access rights, resource usage, and data handling rules, is consistently and transparently enforced across distributed environments.)

In one embodiment, the present disclosure includes a policy specification layer where stakeholders define access controls machine-readable identifier (one example being, a Uniform Resource Identifier (URI) refers to a machine-readable string that uniquely identifies a resource, policy, or object within the governance processor system. A URI may specify a resource by location (e.g., a URL), by name (e.g., a URN), or through another standardized identifier scheme. Within the present disclosure, URIs are used to reference stakeholder agreements, compiled policy artifacts, datasets, enclave configurations, and audit records. By binding policies and control logic to URIs, the governance processor ensures that resources, such as AI models, firmware update packages, and DSP instruction packages, can be consistently authenticated, verified, and enforced across distributed clusters and enclaves, regardless of their physical location or underlying manufacturer infrastructure.) to AI models, code, data flow rules, execution limits, and cleanup requirements. These policies are compiled into hardware-executable and verification intermediate, platform-independent instruction set (one example being Bytecode generated from high-level source code and designed for execution by a virtual machine or interpreter. Unlike native machine code, which is compiled directly for a specific processor architecture, bytecode is a compact, abstract representation of program logic that can be validated, transformed, or instrumented before execution), which are distributed to governance processors deployed throughout computing clusters. The governance processors enforce these instructions at critical hardware control points, including data ingress, processing launch, and result egress, thereby establishing a hardware-enforced governance layer across the AI lifecycle.

Each governance processor incorporates a three-domain architecture comprising: (i) an immutable execution core for policy enforcement and verification, and control point management; (ii) an isolated management plane with an embedded MicroPython interpreter for configuration, diagnostics, and emergency overrides; and (iii) a cryptographic engine for key management, signature verification, and secure storage. This architecture ensures that enforcement cannot be compromised through management interfaces while maintaining operational flexibility.

The present disclosure provides protection for AI workloads, including secure model training in dynamically configured software-defined enclaves, confidential inference execution, protected model storage and deployment, and zero-knowledge state maintenance between operations. The system includes agreement-controlled firmware and microcode updates, eliminating manufacturer lock-in; dynamic enclave configuration for flexible resource allocation; and post-quantum resistant cryptography embedded in hardware.

Accordingly, the governance processor system establishes a new hardware-based trust foundation, enabling secure, flexible, and vendor-independent AI governance across the entire model lifecycle, from training data ingress to inference result egress.

### BRIEF DESCRIPTION OF THE DRAWINGS

FIG. 1 is a block diagram illustrating the governance processor system architecture, showing an external Agreement System (100) connected to a Governance Processor (104) comprising three domains: an Immutable Enforcement Core (110) with hardwired bytecode execution engine, an Isolated Management Plane (112) with embedded interpreter, and a Cryptographic Engine (114) with key storage and verification circuits. The processor interfaces with Cluster Resources (116) including CPUs, GPUs, and TPUs through Hardware Control Points (118).

FIG. 1A is a data flow diagram illustrating the operational sequence of the governance processor system, showing: Agreement Compilation (120) producing Encrypted Bytecode Instructions (122), Instruction Distribution (124) to governance processors, Bytecode Execution (126) within the enforcement core, Encrypted Results Generation (128), Send Encrypted Results (129) to authorized recipients, State Cleanup Operations (130), and Cryptographic Attestation (132) confirming zero-knowledge state achievement.

FIG. 2 is a schematic representation of the policy routing and verification architecture, showing an Agreement Policy (200), a Routing and Verification Layer (202), cryptographic verification (204), pre-compiled hardware instructions (206), and an isolated execution environment (216) including GPU (208), CPU (210), TPU (212), and storage (214).

FIG. 3 is a diagram of the zero-knowledge state maintenance system, illustrating the execution phase (300) with memory states (302-308), cleanup operations (310), clean states (312-318), cryptographic verification (320), and a verified clean subsystem (322).

FIG. 4 is a block diagram of the cryptographic authorization system, showing an Agreement System (400), key derivation (402), encrypted instruction packages (404), a governance processor verification process (406) with validation steps (408-414), and execution decision logic (416-420).

FIG. 5 is a process flow diagram of the secure agreement execution method, illustrating sequential stages of generating instructions (500), distributing to subsystems (502), verifying and executing (504), encrypting results (506), and completing state cleanup (508) across multiple subsystems (510-516), to achieve a zero-knowledge state (518).

FIG. 6 is a schematic illustration of the zero-trust security model, showing the governance processor system (600) as the trusted core, untrusted components (602-608), verified subsystems (610-616), and blocked interactions between untrusted and verified components.

FIG. 7 is a block diagram of the secure AI pipeline under governance processor control, showing training data collection (700), encrypted training data (702), a training enclave (704), encrypted AI models (706), secure storage (708), an inference enclave (710), agreement control (716), and cleanup points (718).

FIG. 8 is a block diagram of the governance processor three-domain architecture (800), showing an immutable enforcement core (802) including a policy routing engine, verification engine, and control point manager; an isolated management plane (804) including a MicroPython interpreter, diagnostic interface, and emergency override; and a cryptographic engine (806) including key management, signature verification, and secure storage.

FIG. 9 is a schematic illustration of governance processor deployment across a computing cluster (900), showing Node 1 (901), Node 2 (902), Node 3 (903), and Node 4 (904), each comprising CPUs, GPUs, or TPUs, with corresponding Governance Processors 1-4 (911-914) enforcing policies at each node.

FIG. 10 is a block diagram of the policy specification layer (1000) and hardware control points, showing access controls (1002), data flow rules (1004), execution limits (1006), cleanup requirements (1008), the compilation process (1010), encrypted distribution (1012), governance processors (1014), and enforcement at data ingress control (1016), processing launch control (1018), result egress control (1020), and cleanup trigger (1022).

### DETAILED DESCRIPTION OF THE DRAWINGS

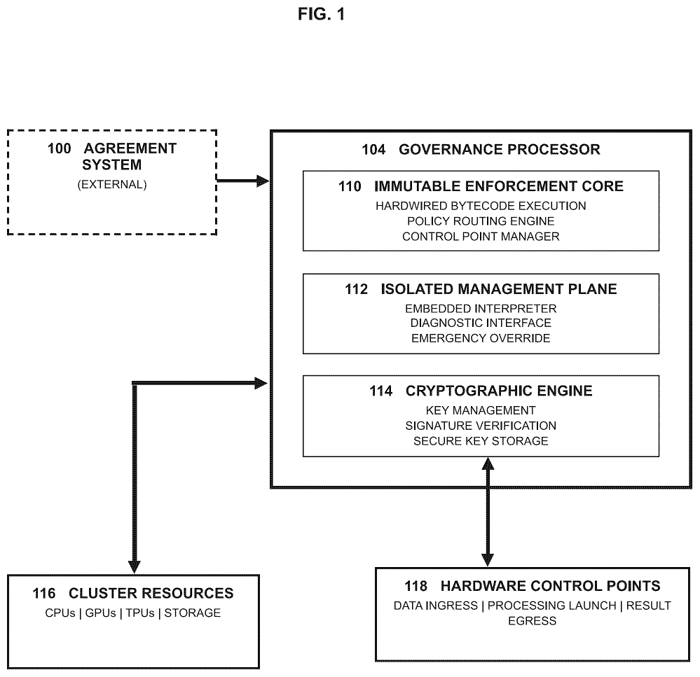

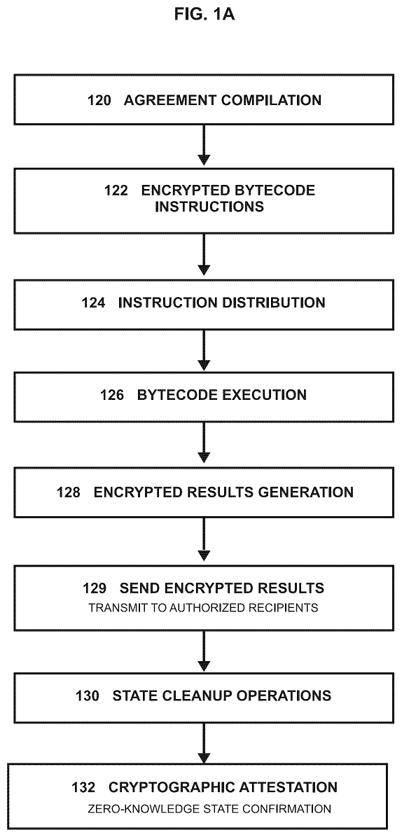

Referring now to FIG. 1, there is shown a block diagram of the governance processor system architecture. The system comprises an external Agreement System (100) that serves as the policy definition and compilation platform. The Agreement System (100) connects to a Governance Processor (104), which represents the core hardware enforcement mechanism. The Governance Processor (104) incorporates three distinct architectural domains: an Immutable Enforcement Core (110) containing hardwired logic for bytecode execution and policy enforcement that cannot be modified post-manufacture; an Isolated Management Plane (112) featuring an embedded interpreter for configuration and diagnostics that operates independently from enforcement logic; and a Cryptographic Engine (114) providing hardware-accelerated key management, signature verification, and secure key storage in tamper-resistant memory. The Governance Processor (104) interfaces with Cluster Resources (116), which include distributed CPUs, GPUs, and TPUs available for enclave creation. Hardware Control Points (118) provide the enforcement interfaces where the governance processor applies policies at data ingress, processing launch, and result egress stages.

Referring now to FIG. 1A, there is shown a data flow diagram illustrating the operational sequence of the governance processor system. The process begins with Agreement Compilation (120), where stakeholder policies defined in the Agreement System are transformed into hardware-executable instructions. This compilation produces Encrypted Bytecode Instructions (122), which are cryptographically protected instruction packages containing compiled policies, resource allocations, and execution parameters. Instruction Distribution (124) securely transmits these encrypted packages to governance processors deployed across the computing infrastructure. Upon receipt, Bytecode Execution (126) occurs within the processor's immutable enforcement core, where instructions are decrypted, validated, and executed according to the hardwired state machine logic. Following execution, Encrypted Results Generation (128) produces cryptographically protected outputs from AI training or inference operations. Send Encrypted Results (129) then transmits these protected outputs to authorized recipients as specified by the stakeholder agreement. State Cleanup Operations (130) subsequently perform comprehensive memory erasure, including GPU memory wiping, cache flushing, and storage sanitization. Finally, Cryptographic Attestation (132) generates a hardware-signed certificate confirming successful cleanup and achievement of zero-knowledge state, completing the governance lifecycle.

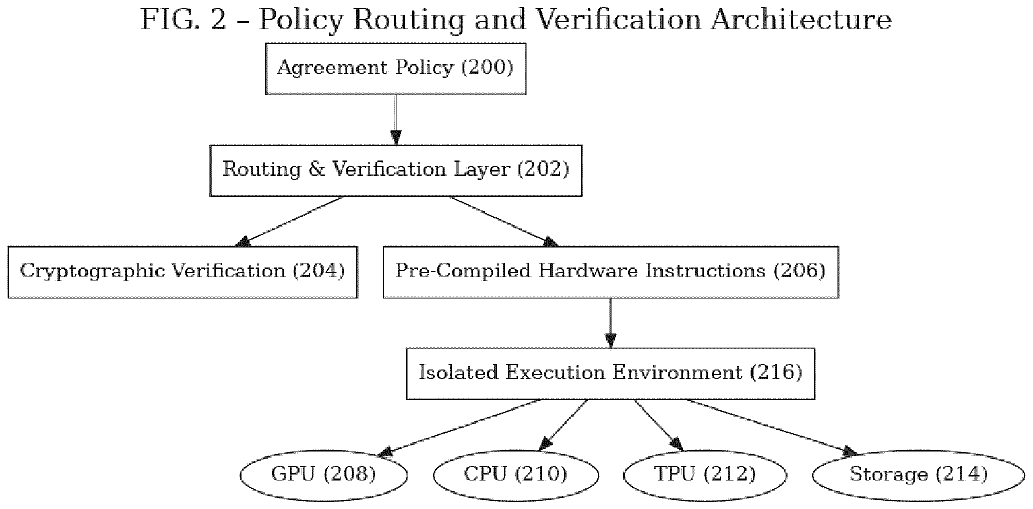

Referring now to FIG. 2, there is shown a schematic representation of the policy routing and verification architecture. An Agreement Policy (200) is supplied to a Routing and Verification Layer (202), which manages code authorization and subsystem routing. The Routing and Verification Layer (202) interacts with Cryptographic Verification (204) to ensure integrity, and Pre-Compiled Hardware Instructions (206) are distributed into an Isolated Execution Environment (216). Within the isolated environment, multiple subsystems such as a GPU (208), CPU (210), TPU (212), and Storage (214) are securely controlled under governance processor enforcement.

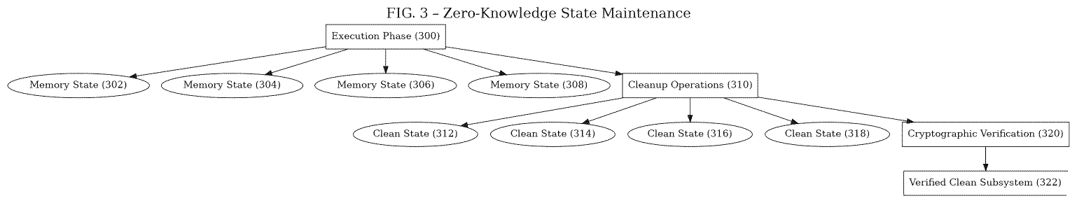

Referring now to FIG. 3, there is shown a diagram of the zero-knowledge state maintenance system. An Execution Phase (300) operates with multiple active memory states (302-308). Following execution, Cleanup Operations (310) overwrite memory, clear caches, and enforce state destruction. The result is a set of Clean States (312-318) that contain no residual information. Cryptographic Verification (320) attests to the completeness of the cleanup, and a Verified Clean Subsystem (322) is established.

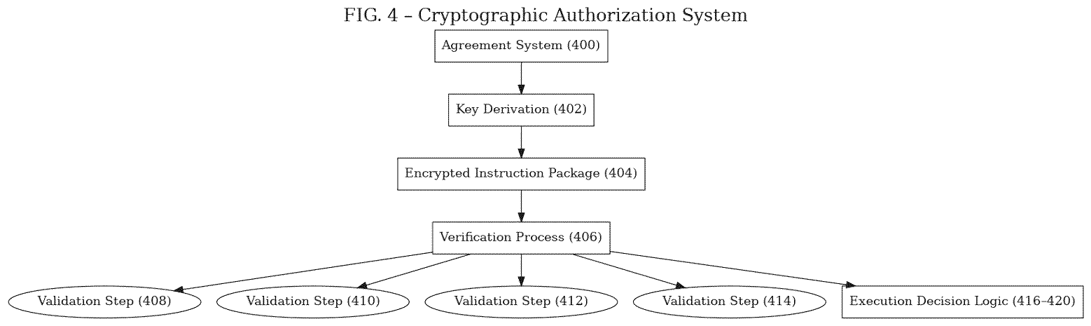

Referring now to FIG. 4, there is shown a block diagram of the cryptographic authorization system. An Agreement System (400) provides master keys to governance processors. Key Derivation (402) generates subsystem-specific keys, which are used to secure Encrypted Instruction Packages (404). A Governance Processor Verification Process (406) evaluates each package through multiple Validation Steps (408-414), and only upon successful validation does the Execution Decision Logic (416-420) authorize execution of the instructions.

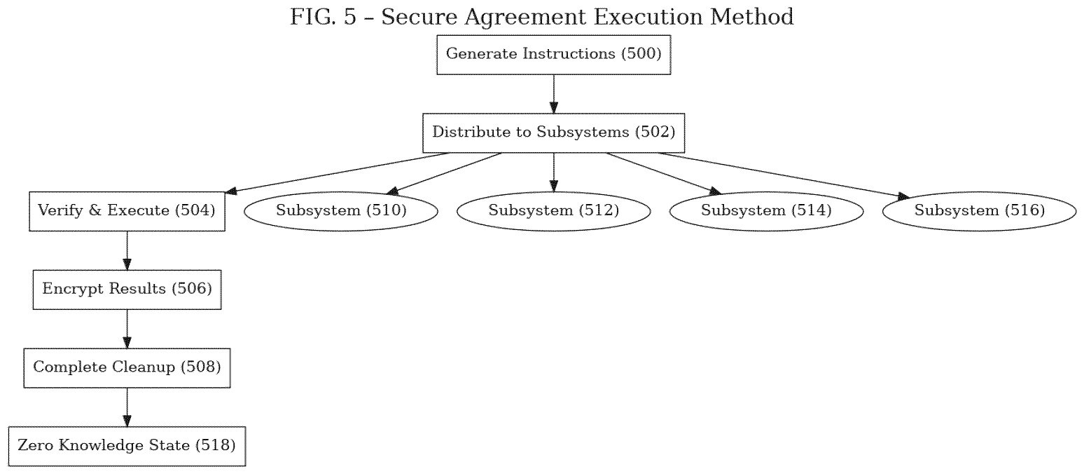

Referring now to FIG. 5, there is shown a process flow diagram of the secure agreement execution method. The process begins with the generation of instructions (500), followed by distribution to subsystems (502). The subsystems perform verification and execution (504), after which results are encrypted (506). A complete state cleanup (508) is then carried out, ensuring no residual data remains. This process applies across multiple subsystems (510-516), culminating in the achievement of a Zero Knowledge State (518).

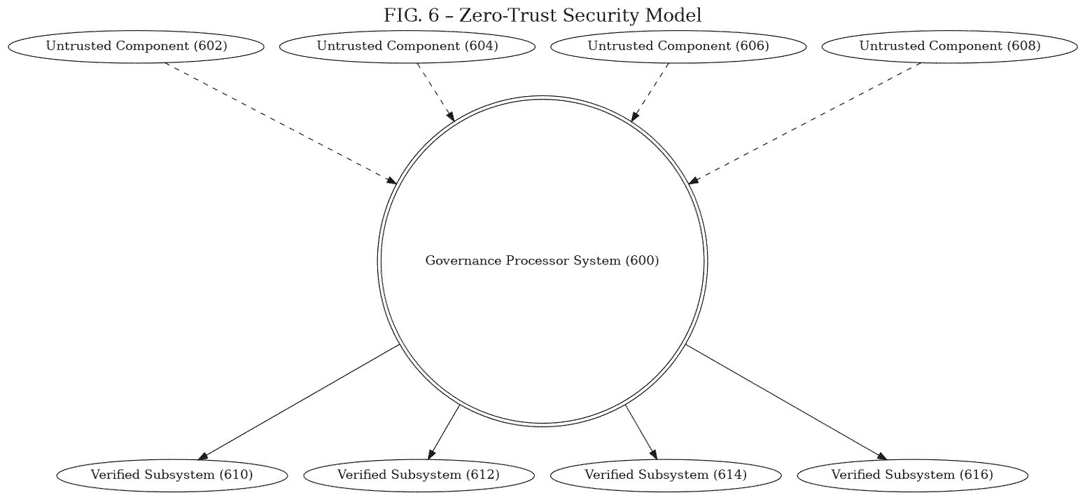

Referring now to FIG. 6, there is shown a schematic illustration of the zero-trust security model. At the center of the architecture is the Governance Processor System (600), which serves as the trusted core. Surrounding the core are untrusted components (602-608), such as operating systems, device drivers, or external network layers. Verified Subsystems (610-616) receive cryptographic validation from the governance processor system. Interactions between untrusted and verified components are blocked, thereby establishing a zero-trust enforcement boundary.

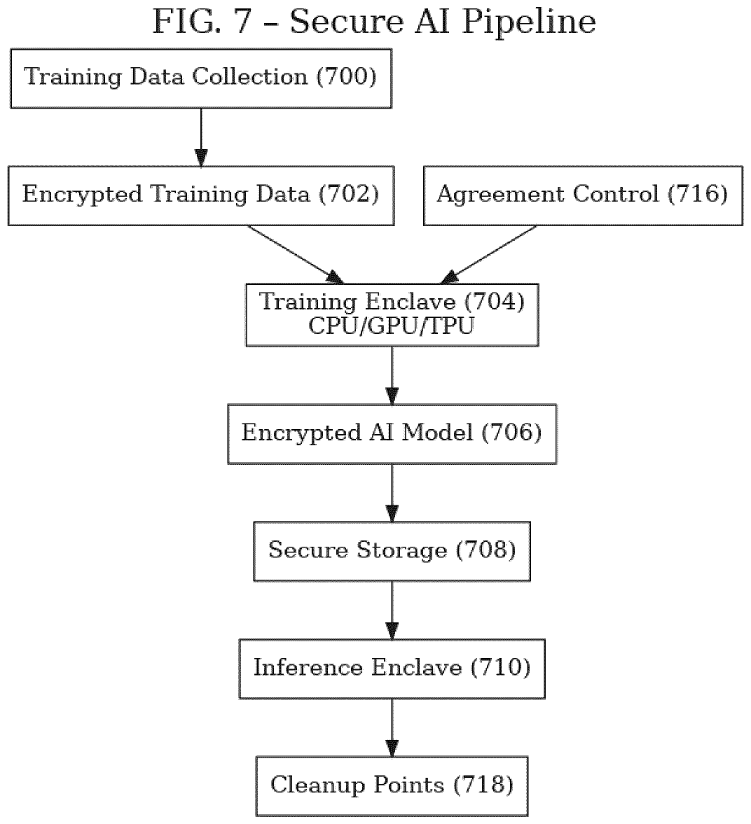

Referring now to FIG. 7, there is shown a block diagram of the secure AI pipeline under governance processor control. Training Data Collection (700) produces Encrypted Training Data (702), which is processed within a CPU/GPU/TPU Training Enclave (704). From this, an Encrypted AI Model (706) is produced and stored in Secure Storage (708). For inference, the model is deployed to an Inference Enclave (710). Agreement Control (716) ensures compliance with stakeholder policies, and Cleanup Points (718) enforce secure state destruction at the end of each lifecycle phase.

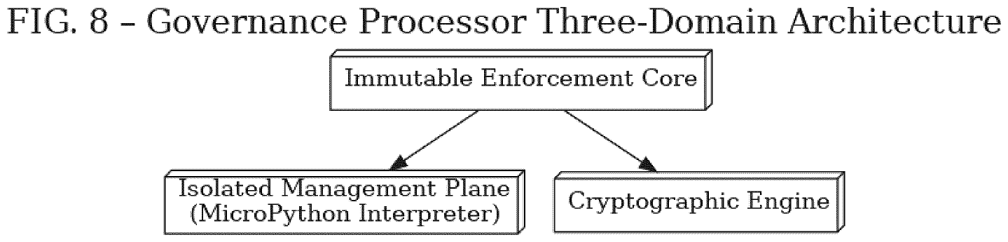

Referring now to FIG. 8, there is shown a block diagram of the governance processor three-domain architecture. A Governance Processor (800) includes three distinct domains. An Immutable Enforcement Core (802) provides hardened logic for policy routing, verification, and control point enforcement. An Isolated Management Plane (804) hosts a local scripting interpreter, such as MicroPython, together with a diagnostic interface and emergency override handler, while remaining isolated from enforcement logic. A Cryptographic Engine (806) provides hardware-accelerated key management, signature verification, and secure storage of cryptographic material. These three domains operate together to enforce stakeholder agreements at the hardware level while maintaining separation of enforcement, management, and cryptographic functions.

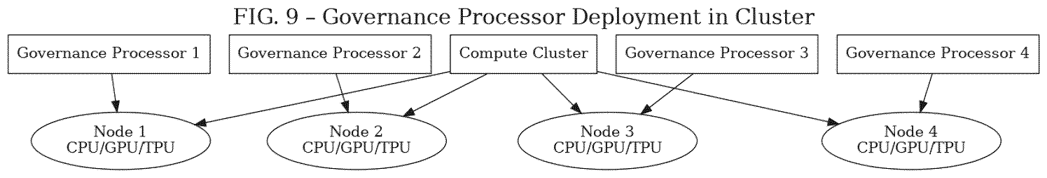

Referring now to FIG. 9, there is shown a schematic illustration of governance processor deployment across a computing cluster. A Compute Cluster (900) comprises multiple nodes including Node 1 (901), Node 2 (902), Node 3 (903), and Node 4 (904), each of which may include CPUs, GPUs, or TPUs. Each node is paired with a dedicated Governance Processor 1 (911), Governance Processor 2 (912), Governance Processor 3 (913), and Governance Processor 4 (914), respectively. Each governance processor enforces stakeholder agreements and hardware-level policies across its associated node. This distributed deployment ensures that governance policies are applied consistently across heterogeneous cluster resources.

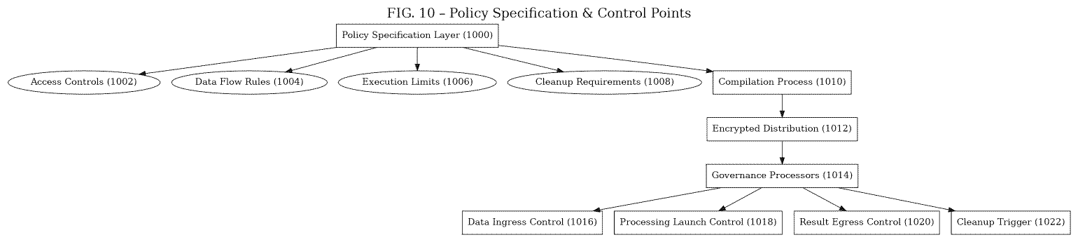

Referring now to FIG. 10, there is shown a block diagram of the policy specification layer and hardware control points. A Policy Specification Layer (1000) defines Access Controls (1002), Data Flow Rules (1004), Execution Limits (1006), and Cleanup Requirements (1008). These policies are transformed by a Compilation Process (1010) into executable instructions, which are securely transmitted through Encrypted Distribution (1012) to distributed Governance Processors (1014). The processors enforce governance at Data Ingress Control (1016), Processing Launch Control (1018), Result Egress Control (1020), and Cleanup Trigger (1022) points, thereby providing full lifecycle enforcement of AI workloads.

### DETAILED DESCRIPTION

### Definitions

The following technical definitions apply throughout this specification:

“Immutable Hardware Enforcement Core” refers to a hardware logic block implemented in read-only memory (ROM) or one-time programmable (OTP) memory, consisting of fixed combinational and sequential logic circuits that cannot be modified after manufacture. The core comprises hardened silicon implementing a bytecode execution engine that receives and processes encrypted bytecode packages. To enable initial operation, the factory provisions a bootstrap configuration that allows the core to receive its first agreement. Upon purchase, the initial owner establishes the agreement key for the first agreement, which defines subsequent agreement authorization protocols. From that point forward, the governance processor is controlled entirely by the active agreement, which may specify how subsequent agreements are authenticated and loaded. The core's logic for agreement verification, bytecode decryption, and instruction execution remains permanently unchanged.

“Policy Specification Layer” refers to a software-to-hardware interface comprising: (a) a JSON schema defining policy syntax, (b) a RESTful API accepting policy definitions, (c) a policy compiler translating JSON to intermediate representation, and (d) a bytecode generator producing hardware-executable instructions. The layer exists external to the governance processor as part of the Agreement System.

“Hardware-Executable Bytecode” this description represents one possible implementation of hardware-executable bytecode. Other implementations may vary in structure or execution. Hardware-executable bytecode is a structured instruction format designed for direct execution by a governance processor's hardwired state machine, eliminating the need for software interpretation. Each instruction consists of the following components, Opcode: Specifies the operation to be performed, Control Point Selector: Identifies the control point for the instruction, Resource Identifier: Points to the specific resource being accessed or manipulated, Cryptographic Signature: Ensures the instruction's authenticity and integrity, Policy Payload: Contains additional data or rules governing the instruction's execution. This format enables efficient, secure, and direct hardware-level processing of instructions.

“Software-Defined Enclave” refers to a logically isolated execution environment dynamically configured from available cluster resources (CPUs, GPUs, TPUs) through governance processor-enforced boundaries. The enclave is established by: (a) allocating compute and memory resources from the cluster pool, (b) configuring hardware isolation via IOMMU, PCIe lane restrictions, and memory segmentation, (c) loading encrypted workloads only within protected memory regions, and (d) enforcing entry/exit controls through the governance processor's hardware control points. Upon completion, all enclave resources undergo cryptographic erasure to ensure zero-knowledge state.

“Zero-Knowledge State” refers to a verified condition where all memory locations have been overwritten with cryptographically random data and subsequently verified through hardware attestation. Verification is performed by hardware comparator circuits checking: (a) GPU memory via multiple overwrite passes and ECC validation, (b) CPU cache via flush, invalidate, and pattern verification, (c) storage via cryptographic erasure and TRIM commands, (d) interconnects via link reset and buffer clearing sequences. The governance processor generates a cryptographic attestation confirming successful erasure.

“Compilation Process” refers to a multi-stage transformation: (1) Lexical analysis tokenizing JSON policies, (2) Syntax tree generation mapping to policy primitives, (3) Semantic analysis validating constraints, (4) Intermediate code generation to platform-agnostic opcodes, (5) Optimization pass removing redundancies, (6) Target code generation for specific governance processor ISA, (7) Cryptographic signing with stakeholder keys.

### Governance Processor Architecture

Referring now to FIG. 10, the present disclosure introduces a governance processor system that establishes a new category of hardware processor. Unlike conventional application processors such as CPUs, GPUs, and TPUs, which perform computation, or security processors such as TPMs, which perform cryptographic operations, the governance processor enforces policies and stakeholder agreements directly at the hardware level. In doing so, it provides a hardware-based governance layer that spans across distributed computing infrastructures. At the top of this architecture, the Policy Specification Layer 1000 serves as the interface where stakeholders define hardware-level control policies governing artificial intelligence (AI) operations.

It should be understood that the Agreement System shown in various figures is external to the governance processor itself. The Agreement System compiles stakeholder policies into encrypted bytecode instructions which are then transmitted to the governance processors.

Each governance processor receives these encrypted bytecode instructions, decrypts them using its cryptographic engine, and executes them through its immutable enforcement core. This separation ensures that policy generation and compilation occur independently from policy enforcement, with the governance processor serving as a hardware-based enforcement mechanism for externally-generated policies.

### Example: Enforcement of a Stakeholder Agreement by Governance Processors

As used herein, stakeholder agreements are machine-readable policy definitions that express authorized parties'rights, obligations, and constraints for AI operations. Referring to FIG. 10 and FIG. 7, consider the following agreement for a sensitive training workload:

### Agreement Clauses (Illustrative)

1. Access: Only “Project-Alpha-Engineers” may use Dataset-A and Model-A.
2. Data residency: All processing must occur in US-West datacenters.
3. Retention: Training data must be destroyed within 30 days of ingestion.
4. Model egress: Trained models may be stored only in Secure Disk Cluster 708 and must not be exported outside the enclave except as encrypted, signed artifacts.
5. Update control: Firmware/microcode may be installed only if signed by both the DPO and CISO keys.
6. Audit: All control-point events must be immutably logged with timestamp and attestation.

### 1) Ingestion at Policy Specification Layer 1000

The agreement maps to the four components of Policy Specification Layer 1000:
Access Controls 1002→role “Project-Alpha-Engineers”; resources Dataset-A, Model-A.
Data Flow Rules 1004→flows constrained to US-West; egress restricted to 708.
Execution Limits 1006→max runtime, GPU count, memory ceilings.
Cleanup Requirements 1008→30-day destruction window; zero-knowledge wipe on task end (718).

### 2) Compilation Process 1010

The Compilation Process 1010 converts those clauses into hardware-executable routing and verification instructions, including:
Ingress routing/verification for pre-compiled parallel computing platform and programming model kernels (GPU) and Rust services (orchestration) with region tags (US-West) and role tokens bound to the workload.
Isolation maps defining the enclave's memory ranges, PCIe/IOMMU rules, and inter-node links.
Retention timers & cleanup opcodes that schedule secure erasure (718) and verify wipe completion via hash attestations.
Egress policies requiring AES-GCM encryption and signature before writes to Secure Disk Cluster 708.
Update gates requiring dual-signature (DPO+CISO) before any firmware/DSP microcode is accepted.

Compiled artifacts are delivered via Encrypted Distribution 1012 to distributed Governance Processors 1014 with 1:N redundancy per enclave.

### 3) Enforcement at Hardware Control Points

Data Ingress Control Point 1016: The governance processor decrypts inbound shards, checks provenance and region tags, verifies access roles, and rejects any payload lacking the required attestations or originating outside US-West.
Processing Launch Control Point 1018: The processor instantiates a software-defined training enclave 704 from the cluster, pins it to US-West nodes, loads only pre-authorized kernels, applies execution limits, and locks DMA/PCIe paths to prevent side-channel leakage.
Result Egress Control Point 1020: On completion, the trained Model-A is encrypted and signed, then routed exclusively to 708. Exports to other regions or stores are blocked in hardware.

### 4) Lifecycle Cleanup, Audit, and Zero-Trust Posture

At enclave teardown, the governance processor executes Cleanup Requirements 1008: GPU memory, caches, scratch NVMe, and interconnect buffers are cryptographically wiped and verified (state cleanup 718). All ingress/launch/egress events are logged with hardware attestation, optionally anchored to a blockchain ledger. In the zero-trust model of FIG. 6, only the governance processor system (600) is trusted; OS, drivers, and network stacks may be compromised without defeating enforcement.

### 5) Agreement-Controlled Updates (Manufacturer Independence)

If a critical accelerator patch is needed, the update control clause is satisfied only when the image carries valid DPO and CISO signatures. The governance processor's cryptographic engine validates both before permitting staged install, no manufacturer gatekeeping required.

Result: The stakeholder agreement is automatically and immutably enforced at hardware control points by governance processors, from data ingress to processing launch to result egress, with verifiable cleanup and audit, realizing policy-driven, vendor-independent AI governance across the entire lifecycle.

In preferred examples, the governance processor is organized into a three-domain architecture designed to balance immutability, flexibility, and security. Immutable Hardware Enforcement Core 110 preferably functions as an immutable domain that includes a policy routing engine for directing compiled instructions to subsystems, a verification engine for ensuring authenticity and authorization of those instructions, and a control point manager for enforcing rules at data ingress, processing launch, and result egress. This domain consists of hardened logic that cannot be altered after manufacture.

Complementing this core, the Isolated Management Plane 112 preferably operates in an isolated local scripting language domain. It hosts an embedded local scripting language interpreter, one example being MicroPython, for setup and configuration, a diagnostic interface for monitoring system health and accessing audit logs, and an emergency override handler for responding to critical anomalies. Importantly, this management plane is completely isolated from the enforcement core, thereby preventing management operations from interfering with enforcement integrity.

Finally, Cryptographic Engine 114 provides hardware-accelerated key management, signature verification, and secure key storage in tamper-resistant memory. This engine establishes the cryptographic trust foundation for the governance processor, ensuring that only authenticated and authorized code executes.

The embedded local scripting language interpreter further supports bootstrapping and initial configuration. Prior to full policy compilation, simple policies may be expressed directly in local scripting language. Once the system is configured, the interpreter can be disabled or locked, permitting only read-only diagnostic queries, thereby preventing unauthorized modification of enforcement policies while retaining visibility into system state.

### Policy Specification and Compilation

The Policy Specification Layer 1000 itself comprises four key components: Access Controls 1002, which define which entities, such as users, processes, or AI models, may access specific hardware resources; Data Flow Rules 1004, which regulate how training data, models, and inference results may traverse between subsystems; Execution Limits 1006, which establish computational and temporal boundaries for AI operations; and Cleanup Requirements 1008, which ensure secure state destruction after completion of AI tasks.

Once defined, these policies are transformed through the Compilation Process 1010, which is an aspect of the present disclosure. Rather than relying on runtime software interpreters, this process converts high-level governance policies into hardware-executable routing and verification instructions. The output may include instructions for pre-compiled parallel computing platform and programming model code (one example being CUDA [Compute Unified Device Architecture] developed by NVIDIA) execution on GPUs, authorization and isolation rules for pre-compiled Rust code in secure environments, validation for pre-compiled local scripting language code on embedded devices, as well as cryptographic signatures for firmware or DSP updates. In addition, tokens and key material are generated for authenticating third-party compiled code, ensuring all compiled workloads comply with governance policies.

Compiled instructions are then delivered via Encrypted Distribution 1012 to distributed Governance Processors 1014. These processors operate with 1:N redundancy per enclave and enforce governance policies at three critical hardware control points: Data Ingress 1016, where incoming training data and models are decrypted, validated, and filtered; Processing Launch 1018, where execution of AI training and inference workloads is initiated under enclave configuration; and Result Egress 1020, where trained models or inference outputs are encrypted, digitally signed, and securely routed to authorized destinations.

### Illustrative Example: Governance Processor-Controlled Cluster and Enclave

As used herein, a cluster refers to a collection of compute nodes, such as CPUs, GPUs, TPUs, or other accelerators, together with their associated memory, storage, and networking, interconnected through a high-speed fabric and managed as a unified resource. Clusters may be homogeneous or heterogeneous and may span local data centers, cloud deployments, or edge environments. Within the governance processor system, clusters provide the computational substrate from which enclaves are dynamically created.

An enclave, as used herein, refers to a software-defined secure execution environment dynamically configured from available cluster resources. Unlike static hardware enclaves, these enclaves are policy-governed and hardware-enforced. Boundaries are established and maintained by governance processors, ensuring isolation from other operations, compliance with stakeholder agreements, and secure cleanup that leaves a zero-knowledge state upon completion.

Referring to FIG. 7 and FIG. 10, consider a training workload for a large language model. The underlying cluster comprises 16 GPU nodes, 4 CPU nodes, and 2 TPU nodes interconnected by an InfiniBand fabric. From this cluster, the Governance Processor System 716 provisions a training enclave 704 consisting of 8 GPUs and 2 CPUs.

At the data ingress control point 1016, governance processors decrypt and validate incoming datasets before allowing them to enter the enclave. At the processing launch control point 1018, the processors configure the enclave boundaries, load compiled parallel computing platform and programming model training instructions and enforce execution limits such as memory usage and runtime constraints. During training, the enclave is cryptographically isolated from other workloads running within the same cluster. Upon completion, the result egress control point 1020 encrypts and signs the trained model before routing it to a secure disk cluster 708. The governance processors then initiate state cleanup 718, cryptographically wiping GPU memory, caches, and temporary files to enforce zero-knowledge retention.

This integrated example demonstrates how the governance processor system transforms general-purpose clusters into policy-controlled computational substrates and, from them, dynamically creates secure enclaves. Together, clusters provide the scale and flexibility of distributed resources, while enclaves deliver the isolation, compliance, and security guarantees needed for sensitive AI operations.

### Secure AI Lifecycle Management

As shown in FIG. 7, the governance processor system provides end-to-end protection across the AI lifecycle. Training data is collected at sensors secure computers and immediately encrypted at the point of generation (702). This data then flows into dynamically configured training enclaves 704, built from available CPU, GPU, and TPU clusters. The Governance Processor Control System 716 manages resource allocation and applies hardware-enforced isolation policies.

Within each enclave, the governance processor ensures that:
Decryption occurs only within protected memory;
Training executes on authorized GPU/TPU resources under enforced isolation;
Concurrent operations remain segregated through hardware boundaries; and
Secure cleanup is performed at the conclusion of training, eliminating any residual state.

Trained models (706) are encrypted before being written into a Secure Disk Cluster 708. For inference, the encrypted model is deployed into a dynamically configured inference enclave 710, again protected by governance processor boundaries. Throughout this process, state cleanup 718 is enforced, and a complete audit trail is logged through governance processor logging and optional blockchain integration.

### Breaking Manufacturer Lock-In

An aspect of the present disclosure is its ability to eliminate reliance on manufacturer-controlled update mechanisms. In conventional architectures, firmware and microcode updates are tightly controlled by vendors, creating dependency risks and security bottlenecks. In contrast, the governance processor system enables agreement-controlled updates, wherein firmware, DSP code, and microcode, whether issued by the manufacturer or third parties, are cryptographically signed, verified, and authorized by the governance processor. This architecture allows organizations to deploy custom firmware, apply rapid security patches, and evolve their ecosystem independently of hardware vendor constraints.

### Software-Defined Secure Enclaves

The system further implements software-defined enclaves that adapt dynamically to available hardware resources, as illustrated in FIG. 7. Unlike fixed hardware enclaves, these enclaves are configured according to stakeholder agreements and can span multiple heterogeneous compute clusters. Governance processors enforce the enclave's boundaries with hardware-level controls and guarantee automatic cleanup upon termination, maintaining a zero-knowledge state.

Such enclaves enable multi-tenant AI infrastructure with hardware-enforced isolation, dynamic scaling based on workload requirements, and secure resource allocation for diverse model architectures.

### Cryptographic Foundations

At its foundation, the governance processor incorporates post-quantum resistant cryptography implemented in hardware. The cryptographic engine supports CRYSTALS-Kyber for key encapsulation, SPHINCS+ for digital signatures, AES-256-GCM for symmetric encryption, SHA3-512 for hashing, and HKDF for key derivation. This combination provides security using post-quantum resistant algorithms while benefiting from hardware acceleration for performance.

### Example Implementation: Secure Model Training

By way of example, consider training a large language model on sensitive corporate data. Administrators first configure the governance processor using the embedded local scripting language interpreter, setting trust roots and default enforcement actions. Stakeholders then define comprehensive policies specifying which GPUs may be used, the retention period for training data, and model access controls. These policies are compiled into enforcement instructions governing how pre-compiled parallel computing platform and programming model training code executes, including isolation boundaries and cleanup rules.

The governance processor validates the parallel computing platform and programming model code against agreement policies, dynamically allocates GPU clusters into a software-defined enclave, and supervises secure training execution. Data is decrypted only in protected GPU memory, intermediate states are never persisted, and the trained model is encrypted at egress. Upon completion, memory and caches are cryptographically wiped, and the entire process is logged, producing an immutable audit trail of model training.

### Zero-Trust Security

Referring now to FIG. 6, the present disclosure operates under a zero-trust security model. Only the governance processor system itself (600) is considered inherently trusted. All other components, including operating systems, device drivers, and network stacks, are treated as potentially compromised. Governance processors enforce a hardware-level trust boundary, ensuring that AI training, inference, and model management remain secure even in adversarial environments. This approach differs from traditional security architectures by shifting trust from software controls to immutable hardware-based governance.

As used herein, the term “zero-knowledge state” refers to a condition in which all intermediate and residual computational states, including GPU/TPU memory, CPU registers, caches, scratch storage, and interconnect buffers, are cryptographically wiped at hardware level and subsequently verified by attestation logic. This ensures that no recoverable information from prior workloads remains available to subsequent processes, thereby enforcing strict lifecycle isolation.

As used herein, “bidirectional control flow” means that governance processors enforce policies symmetrically on both (i) inbound flows of training data and AI models at ingress points, and (ii) outbound flows of inference results and trained models at egress points, ensuring that data confidentiality and integrity are preserved throughout the lifecycle.

Unlike conventional TEEs (e.g., Intel SGX or AMD SEV) or TPMs that operate either as enclaves or cryptographic modules, the governance processor integrates (i) an immutable enforcement core that executes compiled governance bytecode, (ii) an isolated management plane that cannot override enforcement logic, and (iii) a cryptographic engine that validates firmware and microcode updates independent of manufacturer signatures. This architectural separation prevents compromise through vendor lock-in or operating system exploits and enables enforceable policies to be defined and executed directly at hardware level.

### Use Cases

The governance processor system provides implementations across different industries and operational domains. The following use cases demonstrate the practical implementation of the present disclosure in operational scenarios.

### Use Case 1: Tracking Intellectual Property in LLM Training Data

Large language models are trained on massive datasets that may contain copyrighted materials, proprietary documents, and licensed content. The governance processor system provides IP tracking and enforcement throughout the training pipeline. In this use case, IP policies are implemented as smart contracts that automatically enforce attribution, compensation, and usage restrictions.

In this implementation, content owners register their intellectual property with the governance processor system through the Access Controls 1002 of the Policy Specification Layer 1000, establishing which entities may use copyrighted materials and under what conditions. Each registered document or dataset receives a cryptographic fingerprint and associated usage policies encoded as stakeholder agreements. These policies may specify:
Attribution requirements for derivative works
Compensation triggers based on usage metrics
Geographic restrictions on model deployment are enforced through region-specific bytecode compilation.
Temporal limitations on training data retention
Prohibited use cases or applications

When training data enters the system at Data Ingress Control Point 1016, the governance processor performs real-time content fingerprinting and matches against the registered IP database. Detected copyrighted materials trigger the associated policies, which are compiled into hardware-executable bytecode by Compilation Process 1010 and enforced throughout the training process.

During model training in enclave 704, the governance processor maintains an immutable audit trail linking specific training data to model parameters. This creates a cryptographic chain of custody from source documents to trained weights, which act as verifiable IP usage records. The system tracks:
Which documents contributed to specific model capabilities
Usage frequency and duration for each IP asset
Transformation and derivative work creation
Model versioning with IP composition metadata

At Result Egress Control Point 1020, the trained model is tagged with comprehensive IP metadata, including all source attributions, license obligations, and usage restrictions. This metadata is cryptographically signed and bound to the model by Cryptographic Engine 114, preventing unauthorized stripping or modification.

The governance processor 104 enforces ongoing compliance through inference operations. When the model is deployed in inference enclave 710, usage policies travel with it. The system can:
Block inference requests that violate IP restrictions
Generate usage reports for rights holders
Trigger compensation events based on inference volume
Enforce geographic or temporal access controls

This creates an end-to-end IP tracking system where content owners maintain control over their materials after incorporation into AI models, while model developers obtain automated compliance mechanisms.

### Use Case 2: Commercial Pipeline at Cloud Providers (Amazon, Google, Microsoft)

Major cloud providers operate multi-tenant AI infrastructures serving numerous customers with varying security, compliance, and performance requirements. The governance processor system provides these providers with hardware-enforced service guarantees.

In a typical deployment, cloud providers install governance processors across their GPU/TPU clusters, creating a hardware governance fabric spanning multiple availability zones. Each customer tenant receives a unique stakeholder agreement defining:
Allocated compute resources and quotas
Data residency and sovereignty requirements
Compliance frameworks (HIPAA, GDPR, FedRAMP)
Performance guarantees and SLA terms
Security isolation levels
Audit and logging specifications

When a customer initiates an AI workload, the governance processor system dynamically provisions a software-defined enclave from the available cluster resources based on a trusted stakeholder agreement (all external sources are treated as untrusted) For example, a healthcare customer training a diagnostic model would trigger:
1. Enclave Creation: The governance processor allocates 32 GPUs from the cluster, establishing hardware-enforced boundaries that isolate the customer's computation from all other tenants. PCIe paths, memory regions, and network interfaces are locked to prevent cross-tenant leakage. The dynamic configuration of enclaves is based on customer requirements and SLA terms.
2. Compliance Enforcement: HIPAA policies are compiled into bytecode that enforces encryption at rest and in transit, maintains detailed access logs, and ensures data never leaves designated regions. The governance processor blocks any operation that would violate these requirements at the hardware level.
3. Resource Management: The customer's agreement specifies burst capacity up to 64 GPUs during peak hours. The governance processor dynamically scales the enclave, adding or removing resources while maintaining isolation boundaries.
4. Metering and Billing: Every GPU cycle, memory access, and network transfer is tracked by the governance processor with cryptographic attestation. This creates an immutable usage record for transparent billing and chargeback.
5. Competitive Isolation: When multiple customers from competing firms run simultaneous workloads, the governance processor ensures complete isolation of customer workloads in both directions, preventing data leakage into and out of tenant enclaves. Even if the underlying OS is compromised, hardware-level enforcement prevents any information leakage between competitors. Cryptographic wiping of all memory and caches between different customer workloads provides hardware-enforced cleanup between tenant switches and ensures that no residual data remains accessible.

The cloud provider implementation provides:
Compliance certification through hardware-enforced controls
Isolated compute services with hardware-level separation
Reduced operational overhead through automated policy enforcement
Protection from customer workloads compromising infrastructure
Vendor-independent updates without waiting for manufacturer patches This allows cloud providers to implement GPU clusters with hardware-backed security and compliance guarantees.

### Use Case 3: End-to-end Creative Pipeline From Design to Manufacturing

The governance processor system enables secure, traceable workflows from digital design through physical manufacturing, protecting intellectual property and ensuring authorized production across distributed supply chains.

Consider a product development pipeline where a designer using Adobe Creative Cloud or Autodesk Fusion 360 creates a proprietary component design. The workflow proceeds as follows:

Design Phase Protection: When the designer creates the initial CAD model or creative asset, the governance processor at their workstation immediately encrypts and signs the file. The designer's stakeholder agreement specifies:
Ownership and licensing terms
Authorized manufacturers and production quantities
Material and quality specifications
Geographic restrictions on production
Royalty and payment structures

Collaborative Development: As the design moves through review and refinement, potentially involving external engineering firms or consultants, the governance processor maintains access control and version tracking. Each participant operates within a governance processor-controlled enclave that:
Decrypts the design only within protected memory
Prevents unauthorized copying or screenshots
Logs all modifications with attribution
Enforces view-only or edit permissions per the agreement
Maintains zero-knowledge state after each session

Pre-Production Validation: When the design enters simulation and testing, the governance processor ensures that proprietary geometries and parameters remain protected. Whether running FEA analysis, CFD simulations, or generative design iterations on cloud GPU clusters, the governance processor:
Creates isolated enclaves for each simulation run
Prevents extraction of design parameters from simulation results
Maintains audit trails for compliance and IP protection
Enforces data residency for ITAR-controlled designs

Manufacturing Authorization: Production limits and authorization requirements are compiled into bytecode, and the bytecode is securely transmitted to governance processors across the supply chain, from design work stations to manufacturing facilities. When the validated design is sent to manufacturing equipment such as an HP Multi Jet Fusion 3D printer or industrial CNC machine, the governance processor system provides critical controls:
1. Production Authentication: The governance processor at the manufacturing facility verifies the design's cryptographic signature and checks production authorization against the stakeholder agreement. Unauthorized designs are rejected before reaching the equipment.
2. Quantity Enforcement: The agreement specifies production of 1,000 units. The governance processor maintains a distributed ledger tracking each manufactured part. After 1,000 units, the equipment automatically refuses to produce more without a new authorization.
3. Material Verification: For aerospace applications, the governance processor verifies that specified materials (e.g., titanium alloy grade 5) are loaded in the equipment before permitting production, preventing substitution fraud.
4. Quality Attestation: Each manufactured part receives a unique cryptographic certificate from the governance processor, attesting to its authorized production, material compliance, and manufacturing parameters. This creates an unforgeable chain of custody from design to physical part.
5. Design Protection: After completing the authorized production run, the governance processor executes hardware-level cleanup, cryptographically wiping the design from the manufacturing equipment's memory, preventing unauthorized reproduction.

Supply Chain Integration: As parts move through the supply chain, governance processors at each stage verify authenticity and authorization:
Logistics providers can verify shipment contents without accessing design data
Customs authorities can validate compliance without exposing IP
End customers can authenticate parts against the original design certificate
Warranty claims can be verified against the immutable production record

This end-to-end system provides secured manufacturing where:
Designers maintain control over their IP throughout production
Manufacturers can prove authorized production and material compliance
Counterfeit parts are detectable through cryptographic verification
Production quantities are hardware-enforced
Design data is protected on equipment through hardware-level controls

The governance processor system thus provides distributed manufacturing with IP owners maintaining control of their designs through hardware-enforced policies across the production chain.

What is claimed is:

1. A governance processor system for secure artificial intelligence (AI) lifecycle management across distributed computing environments, the system comprising:
a policy specification layer configured to define access controls, data flow rules, execution limits, and state cleanup requirements for AI operations;
a compilation process configured to transform the policy specification into hardware-executable bytecode instructions; and
a plurality of governance processors distributed across computing clusters, each governance processor comprising:
an immutable hardware enforcement core for routing, verification, and enforcement of said bytecode at hardware control points including data ingress, processing launch, and result egress;
a management plane comprising an isolated local scripting interpreter for configuration, diagnostics, and emergency overrides, said management plane being isolated from the enforcement core; and
a cryptographic engine configured for hardware-accelerated key management and signature verification, enabling vendor-independent firmware and microcode updates;
wherein the governance processors enforce bidirectional control flow by securing both inbound training data and outbound inference results, and maintain a zero-knowledge state through hardware-enforced cleanup operations.

2. A governance processor, comprising:
an immutable enforcement core configured to enforce stakeholder agreements expressed as machine-readable policies;
a management plane comprising an isolated local scripting language interpreter configured for configuration, diagnostics, and overrides without overriding enforcement logic; and
a cryptographic engine configured to perform key management, post-quantum resistant signature verification, and secure storage of cryptographic material.

3. A method for enforcing governance of artificial intelligence (AI) lifecycle operations across distributed computing environments, the method comprising:
receiving a policy specification defining access controls, data flow rules, execution limits, and cleanup requirements for AI operations;
compiling the policy specification into hardware-executable bytecode instructions;
distributing the bytecode instructions to a plurality of governance processors deployed across computing clusters; and
enforcing the bytecode instructions at hardware control points, including data ingress, processing launch, and result egress, to ensure secure execution, zero-knowledge cleanup, and agreement-controlled updates.

4. The system of claim 1, wherein the policy specification layer generates stakeholder agreements in the form of smart contracts that are automatically enforced by the governance processors.

5. The system of claim 1, wherein the governance processors dynamically configure software-defined enclaves from available CPUs, GPUs, and TPUs, and enforce enclave boundaries through hardware-level policy enforcement.

6. The system of claim 1, wherein the cleanup requirements comprise cryptographically wiping volatile and non-volatile storage, including GPU/TPU memory, caches, and interconnect buffers, to establish a zero-knowledge state.

7. The system of claim 1, wherein the governance processors are configured to require dual authorization signatures from independent parties before accepting firmware or microcode updates.

8. The system of claim 1, wherein the policy compilation process generates platform-independent bytecode instructions validated by the governance processors prior to execution.

9. The system of claim 1, wherein compiled governance bytecode enforces region-specific data residency requirements across distributed computing clusters.

10. The processor of claim 2, wherein the cryptographic engine supports CRYSTALS-Kyber for key encapsulation, SPHINCS+ for digital signatures, AES-256-GCM for symmetric encryption, and SHA3-512 for hashing.

11. The processor of claim 2, wherein the immutable enforcement core comprises a routing engine, a verification engine, and a control point manager configured to enforce policies at hardware ingress, processing, and egress points.

12. The processor of claim 2, wherein the management plane is restricted to configuration and diagnostic functions and cannot alter enforcement logic.

13. The method of claim 3, further comprising dynamically allocating hardware resources into software-defined enclaves with enforced boundaries.

14. The method of claim 3, further comprising cryptographically verifying cleanup operations to attest to zero residual data after AI training or inference tasks.

15. The method of claim 3, wherein enforcement of policies includes blocking unauthorized model exports and ensuring encrypted, signed storage of outputs.

16. The method of claim 3, wherein firmware and microcode updates are validated against stakeholder agreements independent of manufacturer control.

17. The system of claim 1, wherein governance processors enforce bidirectional control flow by applying policies both to inbound training data and outbound inference results.

18. The system of claim 1, wherein audit logs of governance enforcement events are immutably recorded and optionally anchored to a blockchain ledger.

19. The processor of claim 2, wherein enclaves are configured to support multi-tenant AI operations with hardware-isolated execution boundaries.

20. The method of claim 3, wherein governance processors enforce zero-trust security by treating only the stakeholder agreement as trusted while all external resources, including operating systems, device drivers, networks, and third-party components, are considered untrusted.
